(19) United States
(12) Patent Application Publication
(10) Pub. No.: US 2026/0277045 A1
(43) Pub. Date: Sep. 17, 2026

(54) DISPLAY DEVICE

(71) Applicant: AmTRAN Technology Co., Ltd., New Taipei City (TW)

(72) Inventors: Chih Chien HUNG, New Taipei City (TW); Chien-Chi CHENG, New Taipei City (TW); Hsien Kai LIN, Taipei City (TW)

(21) Appl. No.: 19/441,778

(22) Filed: Jan. 6, 2026

(30) Foreign Application Priority Data
Mar. 14, 2025 (TW) 114109697

(51) Int. Cl. G02F 1/1333

(52) U.S. Cl. CPC G02F 1/133314

(57) ABSTRACT

A display device includes a backplate, a plastic frame, some clamping pieces, some fastening pieces and a display panel. The backplate includes a wall and a base having some fastening holes. The wall has oppositely a first end and a second end. The first end connects the base. The plastic frame includes an abutting portion, a supporting portion and a clamped portion. The abutting portion is located outside the backplate and abuts against the wall. The supporting portion is connected with the abutting portion and rests on the second end. The clamped portion connects the abutting portion. Each clamping piece abuts against the base and clamps the clamped portion. Each clamping piece has a through hole aligned with a corresponding fastening hole. The fastening pieces penetrate through the through holes and are fastened into the fastening holes. The display panel connects the supporting portion.

### RELATED APPLICATIONS

This application claims priority to Taiwanese Application Serial Number 114109697, filed Mar. 14, 2025, which is herein incorporated by reference in its entirety.

### BACKGROUND

### Technical Field

The present disclosure relates to display device. More particularly, the present disclosure relates to capacitive touch LCD devices.

### Description of Related Art

The current trend in video display devices is toward large screens and multi-touch capabilities to allow multiple participants to use the video display device simultaneously for online meetings. Since movable video display devices are frequently moved or rotated, their backlight modules are typically secured with screws and an aluminum front frame, forming a border around the display panel to reinforce the structure. However, such designs not only increase the overall sizes of the display devices, but also cover part of the viewable region at the edge portion of the LCD panel, causing inconvenience. Therefore, there is a need for a narrow-bezel video conferencing display device with reinforced structure to meet market demands.

### SUMMARY

A technical aspect of the present disclosure is to provide a display device, which can make the width of the bezel to become narrowed at low cost, such that the display device can be conveniently viewed and used by a user.

According to an embodiment of the present disclosure, a display device includes a backplate, a plastic frame, a plurality of clamping pieces, a plurality of fastening pieces and a display panel. The backplate includes a base and a wall. The base has a plurality of fastening holes. The wall has a first end and a second end opposite to the first end. The first end is connected with an edge of the base. The plastic frame includes an abutting portion, a supporting portion and a clamped portion. The abutting portion is located outside the backplate. The abutting portion abuts against the wall. The supporting portion is connected with the abutting portion and rests on the second end. The clamped portion is connected with the abutting portion on a side away from the wall. Each of the clamping pieces abuts against the base. Each of the clamping pieces clamps the clamped portion. Each of the clamping pieces has at least one through hole. The through hole is aligned with a corresponding one of the fastening holes. The fastening pieces respectively penetrate through the through hole of one of the clamping pieces. The fastening pieces are respectively fastened into a corresponding one of the fastening holes. The display panel is connected with the supporting portion on a side away from the base.

In one or more embodiments of the present disclosure, each of the clamping pieces includes a lower plate, an upper plate and a connecting plate. The lower plate abuts against the base. The through hole is located at the lower plate. The clamped portion is at least partially located between the upper plate and the lower plate. The upper plate is configured to press against the clamped portion. The connecting plate is connected between the upper plate and the lower plate.

In one or more embodiments of the present disclosure, the upper plate and the abutting portion have a gap therebetween.

In one or more embodiments of the present disclosure, an edge of the clamped portion abuts against the connecting plate.

In one or more embodiments of the present disclosure, the clamped portion and the supporting portion form an opening therebetween. The upper plate is at least partially inserted into the opening.

In one or more embodiments of the present disclosure, the lower plate, the upper plate and the connecting plate are one-piece integrally formed.

In one or more embodiments of the present disclosure, the plastic frame further includes at least one limiting portion. The limiting portion is connected with the abutting portion, the supporting portion and the clamped portion. The limiting portion is configured to position one of the clamping pieces clamping the plastic frame.

In one or more embodiments of the present disclosure, a number of the through hole of each of the clamping pieces is plural. The through holes are arranged along a first direction. The lower plate and the connecting plate are arranged along a second direction. The second direction is perpendicular to the first direction.

In one or more embodiments of the present disclosure, the wall includes a first sub-base, a second sub-base and a third sub-base. The third sub-base is connected between the first sub-base and the second sub-base. The fastening holes are located at the first sub-base. The first sub-base and the second sub-base have a height difference therebetween. The display device further includes a plurality of optical elements. The optical elements are at least partially disposed between the supporting portion and the base. The optical elements are at least partially stacked on the second sub-base. At least one of the optical elements covers the fastening holes.

In one or more embodiments of the present disclosure, a vertical projection of the supporting portion towards the first sub-base at least partially overlaps with the optical elements.

In one or more embodiments of the present disclosure, a portion of the vertical projection of the supporting portion overlapped with the optical elements has a width. A range of the width is between 3 mm and 4 mm.

In one or more embodiments of the present disclosure, the optical elements are spaced apart from the supporting portion.

In one or more embodiments of the present disclosure, the optical elements are spaced apart from the first sub-base.

In one or more embodiments of the present disclosure, the supporting portion includes a first section and a second section connected with the first section. The first section and the second section are respectively parallel with the base. The first section is supported at the second end. The second section is located outside the wall.

In one or more embodiments of the present disclosure, the first section extends to an inner side of the wall and at least partially covers the optical elements.

In one or more embodiments of the present disclosure, the clamping pieces are spaced apart from each other.

In one or more embodiments of the present disclosure, the clamping pieces are respectively a metal piece.

In one or more embodiments of the present disclosure, the fastening pieces are respectively a screw, while the fastening holes are respectively a threaded hole.

According to an embodiment of the present disclosure, a display device includes a backplate, a plastic frame, at least one clamping piece, at least one fastening piece and a display panel. The backplate includes a base and a wall connected with the base. The base has a first outer surface. The wall has a second outer surface. The first outer surface and the second outer surface extend along different directions. The plastic frame includes a supporting portion, a clamped portion and an abutting portion connected between the supporting portion and the clamped portion. The abutting portion abuts against the second outer surface. The supporting portion is supported by an edge of the wall away from the base. The clamped portion is protruded from a side of the abutting portion away from the wall. The clamping piece includes a fastening portion and a hook portion connected with the fastening portion. The fastening portion at least partially abuts against the first outer surface. The hook portion clamps the clamped portion. The fastening piece penetrates through the fastening portion and is fastened to the base. The display panel is connected with the supporting portion on a side away from the base.

According to an embodiment of the present disclosure, a display device includes a backplate, a plastic frame, at least one clamping piece and a display panel. The backplate includes a base and a wall connected with the base. The wall and the base extend along different directions. The plastic frame includes a supporting portion, a clamped portion and an abutting portion connected between the supporting portion and the clamped portion. The abutting portion abuts against the wall at an outer side of the backplate. The supporting portion forms a platform which extends to cover a portion of the base and the clamped portion. The clamped portion is protruded outwardly from the abutting portion. The clamping piece includes a fastening portion and a clamping portion connected with the fastening portion. The fastening portion at least partially abuts against an outer surface of the base. The clamping portion clamps the clamped portion, in which the clamping portion is covered by the platform formed by the supporting portion. The display panel is supported by a portion of the platform formed by the supporting portion.

The above-mentioned embodiments of the present disclosure have at least the following advantages:
(1) Since the clamping pieces respectively clamp the clamped portion of the plastic frame, and the clamping pieces are fastened to the base of the backplate by the fastening pieces, the plastic frame is fixed to the wall of the backplate without additional fastening units. Therefore, the width of the plastic frame in a horizontal direction can be reduced, and the width of the bezel surrounding the display screen of the display device is also narrowed. In addition, only the peripheral of the display panel will be obstructed by the supporting portion, making the display device to be conveniently viewed and used by a user.
(2) Since at least one optical element covers the fastening hole, while the optical element can separate the light cavity from the fastening hole, even if a foreign particle passes through the fastening hole during the assembly of the display device, the optical element can avoid the foreign particle from falling into the light cavity, thereby improving the production yield of the display device.

### BRIEF DESCRIPTION OF THE DRAWINGS

The disclosure can be more fully understood by reading the following detailed description of the embodiments, with reference made to the accompanying drawings as follows:

FIG. 1 is a schematic bottom view of a display device according to an embodiment of the present disclosure;

FIG. 2 is an enlarged view of the zone M of FIG. 1, and

FIG. 3 is a sectional view along the sectional line A-A of FIG. 2.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

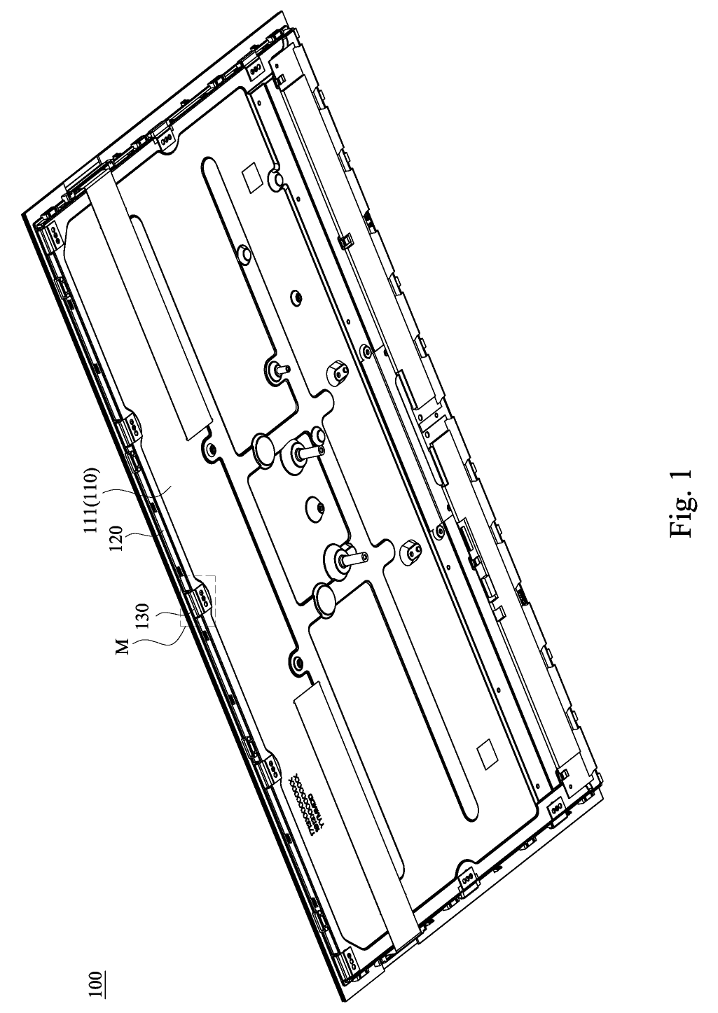

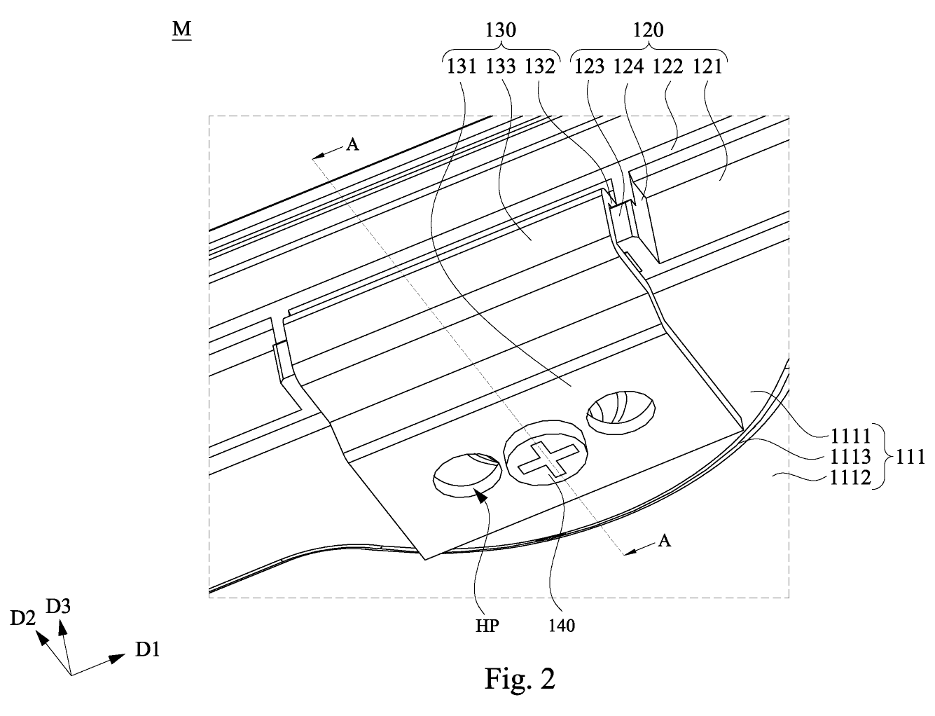

Reference is made to FIGS. 1-2. FIG. 1 is a schematic bottom view of a display device 100 according to an embodiment of the present disclosure. FIG. 2 is an enlarged view of the zone M of FIG. 1. In this embodiment, as shown in FIGS. 1-2, a display device 100 includes a backplate 110, a plastic frame 120, a plurality of clamping pieces 130 and a plurality of fastening pieces 140 (please see FIG. 2 for the fastening pieces 140). The clamping pieces 130 are located at an edge of the backplate 110 and secured to the backplate 110 by the fastening pieces 140. The clamping pieces 130 structurally fasten the plastic frame 120, such that the plastic frame 120 is clamped between the clamping pieces 130 and the backplate 110. In an embodiment of the present disclosure, the clamping pieces 130 can be rigid metal pieces that are not easily deformed.

In an embodiment of the present disclosure, the clamping pieces 130 are distributed along sides of the backplate 110, so as to reinforce the lateral structures of the display device 100. Depending on the sizes of the display devices, backplates 110 of different dimensions can be equipped with varying numbers of clamping pieces 130 for fastening. In contrast, the traditional one-piece aluminum front frames must be specifically designed and manufactured to match the sizes of the display devices, which is incompatible with backplates 110 of different sizes.

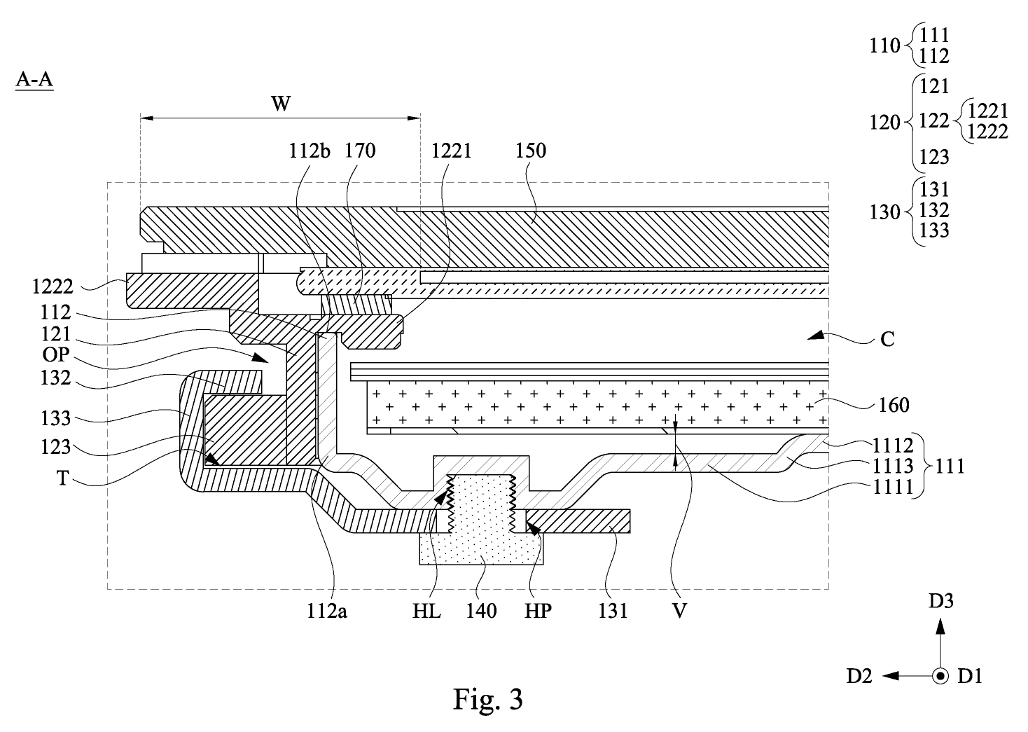

Reference is made to FIG. 3. FIG. 3 is a sectional view along the sectional line A-A of FIG. 2. In this embodiment, as shown in FIG. 3, the backplate 110 includes a base 111 and a wall 112. The base 111 has a fastening hole HL extending along a third direction D3. The third direction D3 is substantially perpendicular to the base 111. The wall 112 substantially extends along the third direction D3. The wall 112 has a first end 112a and a second end 112b opposite to the first end 112a. The first end 112a is connected with an edge of the base 111. Moreover, the plastic frame 120 includes an abutting portion 121, a supporting portion 122 and a clamped portion 123. The abutting portion 121 is located outside the backplate 110 and abuts against the wall 112. In other words, the abutting portion 121 and the wall 112 both extend along the third direction D3. The supporting portion 122 is connected with the abutting portion 121 and rests on the second end 112b of the wall 112. The supporting portion 122 forms a support platform to support a LCD panel 150. The clamped portion 123 is connected with the abutting portion 121 on a side away from the wall 112. In addition, the clamping piece 130 abuts against the base 111 of the backplate 110. The clamping piece 130 clamps the clamped portion 123 of the plastic frame 120 at outside of the wall 112. The clamping piece 130 has at least one through hole HP which is aligned with the fastening hole HL of the base 111. The fastening piece 140 penetrates through the through hole HP of the clamping piece 130 and is fastened into the fastening hole HL. The display device 100 further includes a display panel 150 and a connecting piece 170. The display panel 150 is connected with the supporting portion 122 of the plastic frame 120 on a side away from the base 111. The connecting piece 170 is connected with the display panel 150 and the supporting portion 122, so as to fix the display panel 150. In an embodiment of the present disclosure, the display device 100 can be a capacitive touch LCD device. The display device 100 further includes a glass cover. The glass cover covers on the display panel 150 and is fixed to the supporting portion 122 on a side away from the base 111. Moreover, the fastening piece 140 may be a screw, while the fastening hole HL may be a threaded hole.

In an embodiment of the present disclosure, the plastic frame 120 can be one-piece or multi-pieces formed structure. The plastic frame 120 covers the wall 112 from the outside while the abutting portion 121 abuts against the wall 112. At least two sides of the plastic frame 120 have a plurality of clamped portions 123 and a plurality of connecting portions. The connecting portions and the clamped portions 123 are separated on the sides of plastic frame 120. A back cover of the display device 100 can be attached to the connecting portions and encloses the backplate 110 and the plastic frame 120. In an embodiment of the present disclosure, since the clamping pieces 130 respectively clamp the clamped portion 123 of the plastic frame 120, and the clamping pieces 130 are fastened to the base 111 of the backplate 110 by the fastening pieces 140, the plastic frame 120 is fixed to the wall 112 of the backplate 110 without additional fastening units. Therefore, the width of the plastic frame 120 in a horizontal direction can be reduced, and the width W of the bezel surrounding the display screen of the display device 100 is also narrowed (please see FIG. 3). In addition, only the peripheral of the display panel 150 will be obstructed by the supporting portion 122, making the display device 100 to be conveniently viewed and used by a user.

In an embodiment of the present disclosure, the clamping piece 130 can be a metal piece, the fastening piece 140 can be a screw, and the fastening hole HL can be a threaded hole. In an embodiment of the present disclosure, as shown in FIG. 2, the clamping piece 130 has a plurality of the through holes HP. Any of the through holes HP can be used to align with the fastening hole HL, facilitating the position adjustment of the clamping piece 130 to align with the clamped portion 123. In an embodiment of the present disclosure, a side of the display device 100, such as the bottom side, is free from any clamping piece 130.

Furthermore, as shown in FIG. 3, the clamping piece 130 includes a lower plate 131, an upper plate 132 and a connecting plate 133. The clamping piece 130 is one-piece integrally formed, in which the connecting plate 133 is connected between the upper plate 132 and the lower plate 131. The lower plate 131 abuts against the base 111 of the backplate 110. The through hole HP is located at the lower plate 131. The clamped portion 123 of the plastic frame 120 is at least partially located between the upper plate 132 and the lower plate 131 of the clamping piece 130. The upper plate 132 is configured to press against the clamped portion 123. In other words, the upper plate 132, the lower plate 131 and the connecting plate 133 of the clamping piece 130 form a slot T, while the clamped portion 123 of the plastic frame 120 is at least partially engaged within the slot T. In an embodiment of the present disclosure, an edge of the clamped portion 123 abuts against the connecting plate 133. Moreover, as shown in FIG. 3, the clamped portion 123 and the supporting portion 122 of the plastic frame 120 form an opening OP therebetween, in which the opening OP faces outwardly. The upper plate 132 of the clamping piece 130 is inserted into the opening OP, and a gap is maintained between the abutting portion 121 and the upper plate 132 of the clamping piece 130 in the opening OP. That is, the upper plate 132 and the abutting portion 121 do not directly contact with each other.

In addition, as shown in FIG. 3, the base 111 includes a first sub-base 1111, a second sub-base 1112 and a third sub-base 1113. The third sub-base 1113 is connected between the first sub-base 1111 and the second sub-base 1112. The fastening holes HL are located at the first sub-base 1111. In an embodiment, a height difference V exists between the first sub-base 1111 and the second sub-base 1112. Specifically, the second sub-base 1112 is closer to the display panel 150 than the first sub-base 1111. Moreover, the display device 100 further includes a plurality of optical elements 160. The optical elements 160 are at least partially disposed between the supporting portion 122 and the base 111. The optical elements 160 are at least partially stacked on the second sub-base 1112 of the base 111. The optical elements 160 are spaced apart from the first sub-base 1111, i.e., the optical elements 160 and the first sub-base 1111 do not directly contact with each other. In practical applications, the optical elements 160 may include a reflective sheet, a light guiding plate, a diffusion sheet and a brightness enhancement sheet sequentially stacked, in which the reflective sheet is disposed on the second sub-base 1112 of the backplate 110. In an embodiment of the present disclosure, the display device 100 adopts an edge-lit backlight module design with the light sources located on the lateral side, but the present disclosure is not limited thereto. The display device 100 may also adopt a direct type backlight module design with the light source disposed on the base 111, or it may incorporate a self-emissive display panel without any optical element 160 or light source.

In an embodiment of the present disclosure, as shown in FIG. 3, the display panel 150 and the optical elements 160 define a light cavity C therebetween. It is worth to note that, at least one optical element 160, such as the reflective sheet, covers the fastening hole HL, while the optical element 160 can separate the light cavity C from the fastening hole HL. Thus, even if a foreign particle passes through the fastening hole HL during the assembly of the display device 100, the optical element 160 can avoid the foreign particle from falling into the light cavity C, thereby improving the production yield of the display device 100. Comparatively, if the fastening hole is formed on the plastic frame and penetrates through the wall of the backplate from a lateral side, the foreign particle may fall into the light cavity C through this fastening hole, affecting the performance of the optical elements 160 and the display panel 150. In an embodiment of the present disclosure, the optical element 160 covering the fastening hole HL is made of a rigid sheet material, attached to or abutting against the second sub-base 1112 of the base 111. The optical element 160 extends parallel to the second sub-base 1112 and outwardly covers the fastening hole HL of the first sub-base 1111 and the third sub-base 1113. There are no other elements or structures disposed between the optical elements 160 and the fastening hole HL or the third sub-base 1113, but the present disclosure is not limited thereto. For example, the optical element 160 covering the fastening hole HL may be made of other materials or have other structures or shapes to fit the first sub-base 1111, the fastening hole HL or the third sub-base 1113. Adhesive members or supporting structures may also be disposed between the optical elements 160 and the first sub-base 1111, the fastening hole HL or the third sub-base 1113.

Moreover, as shown in FIG. 3, the optical elements 160 are spaced apart from the supporting portion 122 of the plastic frame 120, i.e., the optical elements 160 and the supporting portion 122 do not directly contact with each other.

Furthermore, the supporting portion 122 is configured as two sections: a first section 1221 and a second section 1222. The first section 1221 and the second section 1222 are substantially parallel with the base 111. The second section 1222 is located at an outer side of the first section 1221. The first section 1221 of the supporting portion 122 is supported at the second end 112b of the wall 112 and extends to an inner side of the wall 112, such that the first section 1221at least partially covers the optical elements 160. This means the vertical projections of the supporting portion 122 and the optical elements 160 relative to the base 111 at least partially overlap with each other. As shown in FIG. 3, the first section 1221 of the supporting portion 122 at least partially covers a peripheral area of the optical elements 160, in order to avoid light leakage from the optical elements 160. Moreover, the first section 1221 of the supporting portion 122 is connected with the connecting piece 170 and the display panel 150. The second section 1222 of the supporting portion 122 is connected with the glass cover. In an embodiment of the present disclosure, the region of the optical elements 160 covered by the supporting portion 122 ranges from 3 mm to 4 mm.

Please go back to FIG. 2. In an embodiment of the present disclosure, as shown in FIG. 2, the plastic frame 120 further includes at least one limiting portion 124. The limiting portion 124 is connected with the abutting portion 121, the supporting portion 122 and the clamped portion 123. The limiting portion 124 is configured to position one of the clamping pieces 130 clamping the plastic frame 120. The upper plates 132 of the clamping pieces 130 are limited between two limiting portions 124, preventing the plastic frame 120 and the clamping pieces 130 from sliding relatively.

In an embodiment of the present disclosure, as shown in FIG. 2, the clamping piece 130 has three through holes HP. The through holes HP are arranged along a first direction D1, in which only one of the through holes HP aligns with the fastening hole HL, but the present disclosure is not limited thereto. The number of the through holes HP of a single piece of the clamping pieces 130 may be increased or reduced, while the number of the fastening holes HL to be aligned with can also be increased or reduced. A single clamping piece 130 can be fastened to the base 111 by a plurality of the fastening pieces 140. In an embodiment of the present disclosure, the lower plate 131 and the connecting plate 133 of the clamping piece 130 are arranged along a second direction D2. The second direction D2 is perpendicular to the first direction D1.

In conclusion, the aforementioned embodiments of the present disclosure have at least the following advantages:
(1) Since the clamping pieces respectively clamp the clamped portions of the plastic frame, and the clamping pieces are fastened to the base of the backplate by the fastening pieces, the plastic frame is fixed to the wall of the backplate without additional fastening units. Therefore, the width of the plastic frame in a horizontal direction can be reduced, and the width of the bezel surrounding the display screen of the display device is also narrowed. In addition, only the peripheral of the display panel will be obstructed by the supporting portion, making the display device to be conveniently viewed and used by a user.
(2) Since at least one optical element covers the fastening hole, while the optical element can separate the light cavity from the fastening hole, even if a foreign particle passes through the fastening hole during the assembly of the display device, the optical element can avoid the foreign particle from falling into the light cavity, thereby improving the production yield of the display device.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A display device, comprising:
a backplate comprising a base and a wall, the base having a plurality of fastening holes, the wall having a first end and a second end opposite to the first end, the first end connecting with an edge of the base;
a plastic frame comprising an abutting portion, a supporting portion and a clamped portion, the abutting portion being located outside the backplate and abutting against the wall, the supporting portion connecting with the abutting portion and resting on the second end, the clamped portion connecting with the abutting portion on a side away from the wall;
a plurality of clamping pieces, each of the clamping pieces abutting against the base and clamping the clamped portion, each of the clamping pieces having at least one through hole aligning with a corresponding one of the fastening holes;
a plurality of fastening pieces respectively penetrating through the through hole of one of the clamping pieces and being fastened into a corresponding one of the fastening holes; and
a display panel connecting with the supporting portion on a side away from the base.

2. The display device of claim 1, wherein each of the clamping pieces comprises:
a lower plate abutting against the base, the through hole is located at the lower plate;
an upper plate, the clamped portion is at least partially located between the upper plate and the lower plate, the upper plate is configured to press against the clamped portion; and
a connecting plate connected between the upper plate and the lower plate.

3. The display device of claim 2, wherein the upper plate and the abutting portion have a gap therebetween.

4. The display device of claim 2, wherein an edge of the clamped portion abuts against the connecting plate.

5. The display device of claim 2, wherein the clamped portion and the supporting portion form an opening therebetween, the upper plate is at least partially inserted into the opening.

6. The display device of claim 2, wherein the lower plate, the upper plate and the connecting plate are one-piece integrally formed.

7. The display device of claim 2, wherein the plastic frame further comprises:
at least one limiting portion connected with the abutting portion, the supporting portion and the clamped portion, the limiting portion is configured to position one of the clamping pieces clamping the plastic frame.

8. The display device of claim 2, wherein a number of the through hole of each of the clamping pieces is plural, the through holes are arranged along a first direction, the lower plate and the connecting plate are arranged along a second direction perpendicular to the first direction.

9. The display device of claim 1, wherein the wall comprises a first sub-base, a second sub-base and a third sub-base, the third sub-base is connected between the first sub-base and the second sub-base, the fastening holes are located at the first sub-base, the first sub-base and the second sub-base have a height difference therebetween, the display device further comprises:
a plurality of optical elements at least partially disposed between the supporting portion and the base and stacked on the second sub-base, at least one of the optical elements covers the fastening holes.

10. The display device of claim 9, wherein a vertical projection of the supporting portion towards the first sub-base at least partially overlaps with the optical elements.

11. The display device of claim 10, wherein a portion of the vertical projection of the supporting portion overlapped with the optical elements has a width, a range of the width is between 3 mm and 4 mm.

12. The display device of claim 9, wherein the optical elements are spaced apart from the supporting portion.

13. The display device of claim 9, wherein the optical elements are spaced apart from the first sub-base.

14. The display device of claim 9, wherein the supporting portion comprises a first section and a second section connected with the first section, the first section and the second section are respectively parallel with the base, the first section is supported at the second end, the second section is located outside the wall.

15. The display device of claim 14, wherein the first section extends to an inner side of the wall and at least partially covers the optical elements.

16. The display device of claim 1, wherein the clamping pieces are spaced apart from each other.

17. The display device of claim 1, wherein the clamping pieces are respectively a metal piece.

18. The display device of claim 1, wherein the fastening pieces are respectively a screw, the fastening holes are respectively a threaded hole.

19. A display device, comprising:
a backplate comprising a base and a wall connected with the base, the base having a first outer surface, the wall having a second outer surface, the first outer surface and the second outer surface extending along different directions;
a plastic frame comprising a supporting portion, a clamped portion and an abutting portion connected between the supporting portion and the clamped portion, the abutting portion abutting against the second outer surface, the supporting portion being supported by an edge of the wall away from the base, the clamped portion being protruded from a side of the abutting portion away from the wall;
at least one clamping piece comprising a fastening portion and a hook portion connected with the fastening portion, the fastening portion at least partially abutting against the first outer surface, the hook portion clamping the clamped portion;
at least one fastening piece penetrating through the fastening portion and being fastened to the base; and
a display panel connecting with the supporting portion on a side away from the base.

20. A display device, comprising:
a backplate comprising a base and a wall connected with the base, the wall and the base extending along different directions;
a plastic frame comprising a supporting portion, a clamped portion and an abutting portion connected between the supporting portion and the clamped portion, the abutting portion abutting against the wall at an outer side of the backplate, the supporting portion forming a platform which extends to cover a portion of the base and the clamped portion, the clamped portion being protruded outwardly from the abutting portion;
at least one clamping piece comprising a fastening portion and a clamping portion connected with the fastening portion, the fastening portion at least partially abutting against an outer surface of the base, the clamping portion clamping the clamped portion, wherein the clamping portion is covered by the platform formed by the supporting portion; and
a display panel being supported by a portion of the platform formed by the supporting portion.
